(19) United States
(12) Patent Application Publication
(10) Pub. No.: US 2009/0043654 A1
(43) Pub. Date: Feb. 12, 2009

(54) Method And System For Enabling Advertising And Transaction Within User Generated Video Content

(76) Inventor: Daniel L. Bates, El Segundo, CA (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/129,196

(22) Filed: May 29, 2008

Related U.S. Application Data
(60) Provisional application No. 60/932,481, filed on May 30, 2007.

(51) Int. Cl. G06Q 30/00

(52) U.S. Cl. 705/14

(57) ABSTRACT

A method and system of enabling individual internet users to link advertising information to content posted on the internet. At least one internet-coupled server hosts the content an enables individual internet users to view the content. The server enables the individual internet users to link advertising information to a portion of the content on the internet site, and enables a reward to be provided to individual internet users who link advertising information to the portion of the content on the internet site. Preferably the reward is provided each time other internet users click on the link and/or purchase products and/or services through the link Thus, internet advertising is performed by many individuals who are rewarded for their efforts. Preferably, the content s user-generated content such as the video content posted on sites such as YouTube.

### BACKGROUND OF THE INVENTION

1. Field of the Invention

The present invention relates to a method and system for enabling advertising and transactions within user generated video content.

2. Description of the Related Art

In recent years, social networking web sites have become very popular on the internet. For example, on a site available at www.myspace.com, users can register and essentially have their own blog, and post pictures and videos. Other networking web sites such as Facebook, YouTube, etc. also allow registrants to post or share videos with others in the network. Registrants may make comments on their own posted pictures and videos, and they may make comments on the pictures and videos of others. Users of these types of sites may also make comments on pictures and videos posted by others.

Businesses have been reluctant to advertise and/or connect transaction opportunities to such web sites because in many cases the advertiser does not know what material will be appearing in front of or adjacent such advertising and/or transaction opportunity. In other words, there is no control or insufficient control of user generated content to avoid businesses' concerns about tastefulness and appropriateness. For example, an advertisement for alcohol could end up on a page or right before or after a page with a person's blog or video about going to AA (Alcoholics Anonymous), or an advertisement about a bank could end up with a blog or video denigrating that same bank. Alternatively, the subject matter in a blog or video adjacent the advertisement could simply be distasteful to a conservative advertiser.

Further, there is a vast amount of user generated pictures and video on social networks. In general, this vast amount of pictures and video may be accessed by anyone on the internet, particularly since blog text and other text, such as the captions for videos, and comments regarding videos, are generally searchable by search engines such as Google®, MSN® Search, AOL® search and Yahoo!®.

Therefore, if a company could advertise or promote their goods or service in a way that was relevant and took advantage of the vast amount of material on social networks, one could potentially reap vast benefits.

### SUMMARY OF THE INVENTION

In accordance with one embodiment of the present invention, there is a method and system for enabling advertising and transactions within user generated content (“UGC”), and most preferably, within user generated video (“UGV”) content. “UGV” and “UGC” is content provided by individuals not affiliated with or paid by product manufacturers, internet service providers, internet sites, internet search engines, etc. The present invention has recognized, among other things, that the amount of UGV on the internet is growing rapidly, that there is already a vast amount of UGV on the internet, and that creating a way of using all of this UGV for advertising and generating commercial transactions for businesses will provide a tremendous commercial opportunity. Further, the present invention has created a way to use this UGV for advertising and commercial transactions, without any action on the part of businesses, thereby avoiding any potential embarrassment by the businesses paying for advertising that winds up in a compromising proximity to UGV.

In one embodiment, the method and system take advantage of the ability not only of the posting party of the UGV to provide comments and the UGV, but also of the vast number of internet users to do so, in a way that has no upfront cost to businesses. More specifically, in a method in accordance with such embodiment, any internet user who accesses the video may provide a comment and link to a businesses web site or other site, by applying a “tag” (a link with or without a comment). Preferably, the link also includes a comment or at least a keyword or keywords. Any appropriate computer tool (software) may be used to apply the tag. An example is disclosed in U.S. patent application Ser. No. 10/443,301, filed May 21, 2003, (now abandoned), published as US2004/0233233 A1. Such tagging tools will be referred to herein as a “tagging tool.” The item or object, wherever it appears in the UGV, may be tagged by using the tagging tool.

Once the tag is placed, any internet user may use any search engine to find the UGV. An internet user watches the UGV, and clicks (or right clicks) on an item in the UGV of interest. The “tag” or link to a web site is activated, e.g., as a “pop up” window with a comment, such as “I love this purse, which I purchased at the Gucci® store. You can get one too.” The link preferably is to the Gucci® web site, such as a page showing the purse. The link could alternatively be direct to the Gucci® web site, or to the web page on the Gucci® site containing the purse. The UGV may be played, and the links displayed upon clicking or the like, by any suitable video player with a software tool to display the links and carryout linking.

The “tagger” is rewarded for placing the tag by virtue of the tagger receiving monetary or non-monetary remuneration or recognition, such as a fixed fee or percentage based on another user purchasing the purse or based on a click through, or a credit on the business' web site or simple recognition, such as a list of standings as to whom has placed the most tags.

In a preferred embodiment, those who wish to place tags in UGV may register at a web site and receive a unique code to place in the tag. Therefore, the tagger's link will have unique identifying data, such as identifying an account for the tagger. The method includes sending a signal to the registration web site or a database containing the tagger's account and crediting the tagger's account with a predetermined amount each time there is a use of any of the tagger's links, and/or crediting the tagger's account each time there is a transaction at the business to which the link led. The “credit” may be a monetary credit, a coupon-type credit, and/or nonmonetary credit, such as recognition for the tag placement. Standings may be kept, for tag placements and/or for click-through from the tags and/or purchases from the tags.

The system and method results in pay in response to performance of the tag. There are existing pay on a performance basis systems such as Google®, AdWords™ or Google AdSense™. However, these pay on performance systems are used in very different contexts from the present invention.

In the system according to the present invention, anyone, not just certain users, can tag a video and make it clickable or interactive. Therefore, the system provides a way to piggyback on the efforts of potentially any and all internet users, rather than a limited field of users.

According to on aspect of the present invention, a method of enabling individual internet users to link advertising information to user-generated video content posted on the internet includes the steps of: (i) hosting user-generated video content on an internet site; (ii) enabling individual internet users to view the user-generated video content on the internet site; (iii) enabling the individual internet users to link advertising information to a portion of the user-generated video content on the internet site; and (iv) enabling a reward to be provided to individual internet users who link advertising information to the portion of the user-generated video content on the internet site.

According to another aspect of the present invention, a method of enabling individual internet users to link advertising information to content posted on the internet includes the steps of (i) hosting content on an internet site; (ii) enabling individual internet users to view the content on the internet site; (iii) enabling the individual internet users to link advertising information to a portion of the content on the internet site; and (iv) enabling a reward to be provided to individual internet users who link advertising information to the portion of the content on the internet site.

According to yet another aspect of the present invention, apparatus for enabling individual internet users to link advertising information to user-generated content posted on the internet includes at least one server for hosting user-generated content on an internet site. An interface is coupled to the server and is configured to communicate with at least one user computer through the internet. The at least one server is configured to (i) enable individual internet users to view the user-generated content, (ii) enable the individual internet users to link advertising information to a portion of the user-generated content, and (iii) enable a reward to be provided to individual internet users who link advertising information to the portion of the user-generated content.

### BRIEF DESCRIPTION OF THE DRAWINGS

FIG. 1 is a schematic view of multiple users connected to the internet, and a user generated content web site, an account web site, a tools web site (or CD) and sponsor(s) web site(s) in accordance with a system and method of a preferred embodiment of the invention.

FIG. 2 is a flow chart of steps in accordance with one embodiment of the invention.

FIG. 3 is a schematic view of a memory in accordance with one embodiment of the invention.

FIG. 4 is a schematic view of data in a file or files to be sent to be associated with user generated video and objects therein.

### DESCRIPTION OF THE PREFERRED EMBODIMENT(S)

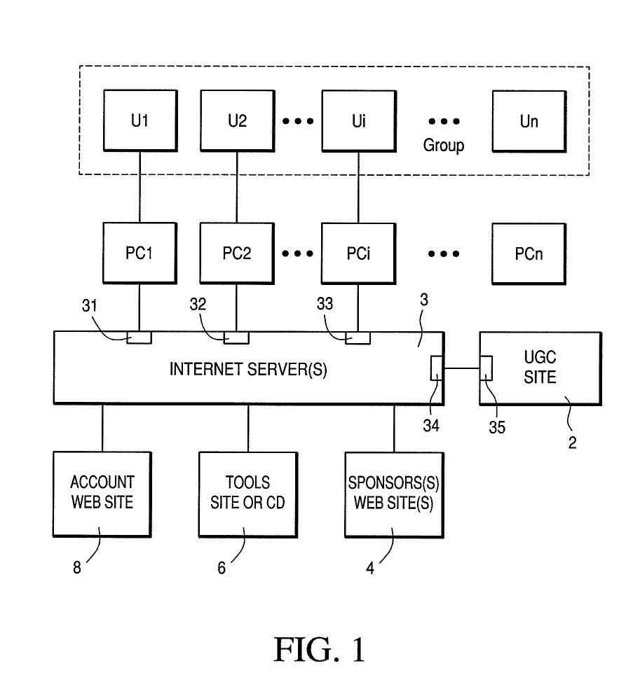

As shown in FIG. 1, there are multiple personal computer users U1, U2, . . . , Ui, . . . , Un who have personal computers PC1, PC2, . . . , PCi, . . . , PCn, with access to one or more internet servers 3. An existing UGC (user generated content) site server(s) 2, such as a social networking site, is also connected to the internet servers 3, and communicates with the PCs through one or more interfaces 31, 32, 33, 34, and 35. The UGC site server 2 preferably contains UGV (or other video). In the preferred embodiment, the inventive method and system apply to tagging UGV, but the method and system may also work with any UGC, such as audio and/or images and/or photos and/or text and/or any combinations of the above. Also connected to the internet are sponsor(s) web site(s) or server(s) 4, i.e., the business web sites from which goods or services may be purchased, a tools web site (or CD or server) 6, and an account website or server 8.

The account web site 8, may be combined with the tools web site 6. The account web site 8 keeps track of account holders, who are internet users that have placed links (“tagged”) UGC, and in particular here, UGV. When a user desires to place tags in accordance with a method and system of the invention, the user preferably registers on the account web site. The object tracking and linking technology (software) preferably contains a link to the account web site for the user to register the first time the user desires to place a tag. Thereafter, the user simply enters user name and/or ID and/or password.

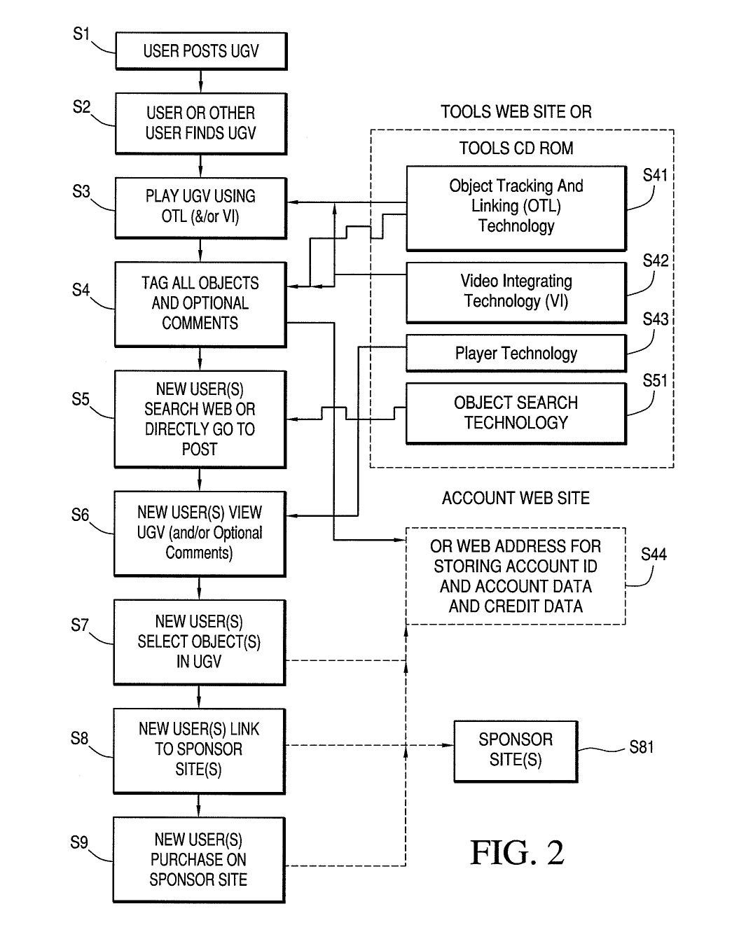

FIG. 2 shows a flow chart of steps in the preferred method. In step S1, one of the users of FIG. 1 posts UGC and in particular UGV on a UGC site, in a conventionally known manner. (In the preferred embodiment, the UGV is in fact UGC, but the video or content need not be entirely user-generated.) The same user, or a different user of FIG. 1, comes upon the posted UGV (or other posted material) in step S2, whether by internet search engine or by directly going to the site, or by link to the site. This user who has found this UGV views it (Step S3), and then tags the video and preferably a particular object or objects therein (Step S4) using object tracking and linking technology (OTL; Step S41), such as OTL described in U.S. Patent Publication Nos.: US2003/0098869 (application Ser. No. 10/039,924); US2004/0233233 (application Ser. No. 10/443,301); US2004/0227768 (application Ser. No. 10/786,777); US2005/0162439 (application Ser. No. 10/219,175); US2006/0277457 (application Ser. No. 11/148,007); application Ser. Nos. 09/679,391, 10/664,350, and 11/519,267; and U.S. Pat. No. 6,774,908. The data in the “tag” file or files preferably includes the data shown in FIG. 4, i.e., video and object location data (VO), linking data (LD) to link to the sponsor(s) web site(s), the internet user's ID, e.g., U1, the internet user's password, e.g., ID1 (optional), and an indication of a type or amount of credit CR to be given to the user. CR may be credit for when another user links to the sponsor site, when another user actually makes a purchase at the sponsor site, or other method of credit, or non-monetary recognition, such as number of “tags” standings, number of “clicks through” standings, or the like. In fact, those at the top in the standings could be provided rewards of any type.

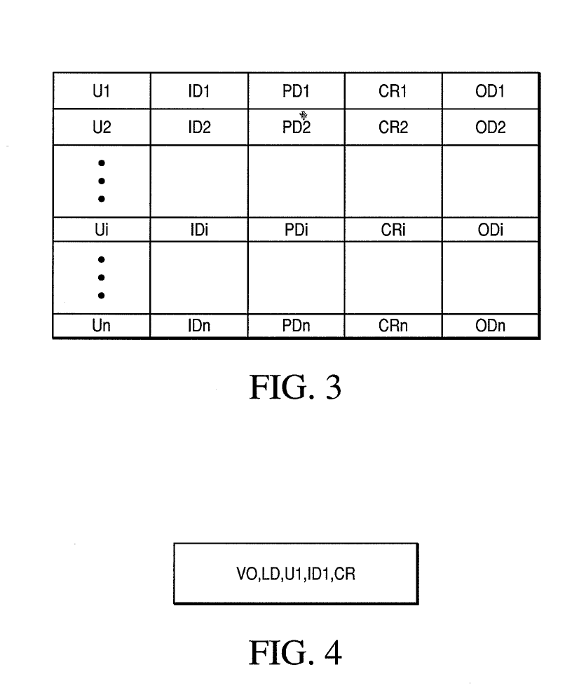

The account web site preferably contains in memory the information shown in FIG. 3. The information includes the user name, e.g., Ui, the user ID, e.g., IDi, some personal data of the user, e.g., PDi (which might be name, address, email address, and other information to verify identity in the event of a forgotten ID), total amount or amounts of credits (as the system can have different types of credits for any user(s)), and other data e.g., ODi. The type of credit may be a credit for a particular sponsor, such as all links to Gucci® that a user receives credit to translate into credit towards a purchase of Gucci® merchandise. Alternatively, the credit may be cash, discounts, and/or other forms of value, or non-monetary recognition.

During tagging, the video integrating technology (VI), such as that described in the above referenced patents, patent publications, and patent applications, may also be used in Step S42, so that the tagged video objects are now searchable. This step preferably results in a higher level of credit or recognition for the user, as it makes the tag more “visible” on the internet.

Alternatively, the level of credit or recognition may be left the same, because the user will be remunerated more by more traffic to the UGV and consequently to the tag(s) placed by that user.

In Step S5, when a new user comes upon the UGV using object search technology (Step S51), it may be played using any media player (Step S34), in Step S6. In addition, the new user may be provided an opportunity to place his or her own tags (in exactly the same manner as the above steps in the flow chart) and/or place comments using appropriate authoring technology.

In Step S7, the new user may then select an object or objects in the UGV, typically by clicking on an object to see if a tag pops up. Examples of tags, how they are placed and executed are described in the above referenced patents, patent publications, and patent applications. Here, the primary difference is that the link data file contains not only the linking data LD and the video and object location data (VO), but also the additional data described above with respect to FIG. 4, so that the user that placed the tag can be compensated.

After the new user has selected an object in FIG. 2, the user may link to a sponsor's (business) web site, in Step S8. The user may alternatively or subsequent thereto be offered a purchase opportunity, in Step S9.

In a preferred embodiment, products seen in videos, which are tagged by users, are identified and then associated with links provided to the user from a network of advertisers/marketers that are within a specific network, such as a UGVT network of a specific company, or a sponsor site in Step S81. The same specific network may also be part of a joint venture with known affiliate networks such as affiliate networks of www.CJ.com (“Commission Junction”), or other affiliate networks.

There are many ways for tagging users to obtain credit and/or remuneration and/or recognition, as noted above. One way is to provide credits to the tagging user and preferably also to the tagging software provider for each link clicked. Another method of remuneration is to provide credit or remuneration for each purchase that comes from a user following a link provided by another user. Again, the tagging user and the tagging software provider may be compensated or credited at that time. The tagging user may receive credit in the form of money, coupons, and/or credit for specific sponsor(s). The tagging software provider would preferably receive compensation in the form of money from the sponsor(s) depending upon the number of links and/or purchases resulting from the links.

Search engines or the like may also be involved in the method and/or system in accordance with the invention. For example, in the embodiment where object search technology is used, sponsors could bid on keywords or phrases similar to how sponsors now do on Google® and other search engines for searches. Accordingly, search engines can be a major player in the ecommerce method and system of the invention.

The present invention therefore leverages the power of the vast number of internet users to provide tags, at no initial cost to sponsors, and to make residual income off of the tags.

The UGV may be played, and the links displayed upon clicking or the like, and activated, using the technology of U.S. patent application Ser. No. 10/664,350, filed Sep. 16, 2003, (and entitled: BANKING VIDEO FRAMES ASSOCIATED WITH LINKS AND PROCESSING THE BANKED FRAMES, herein referred to as “Player” technology).

The object or item in the UGV may be searchable using the technology of U.S. patent application Ser. No. 11/519,267, filed Sep. 12, 2006, owned by Avant and incorporated by reference herein (and entitled: SYSTEM AND METHOD FOR ENABLING OBJECTS WITHIN VIDEO TO BE SEARCHED ON THE INTERNET OR INTRANET, herein referred to as “Object Search” technology).

The segment of the UGV that contains the object or item of interest can even be isolated, and commented on, using the technology of U.S. patent application Ser. No. 11/148,007, filed Jun. 7, 2005, owned by Avant and incorporated by reference herein (and entitled: A METHOD AND APPARATUS FOR INTEGRATING VIDEO INTO WEB LOGGING, herein referred to as “Video Integrating” technology).

Although not necessary to the invention, the Object Tracking and Linking technology, Video Integrating technology, Player technology and Object Search technology may be used in conjunction with the inventive video tagging.

The individual components shown in outline or designated by blocks in the attached Drawings are all well-known in the internet arts, and their specific construction and operation are not critical to the operation or best mode for carrying out the invention.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. patent documents discussed above are hereby incorporated by reference into the Detailed Description of the Preferred Embodiment.

What is claimed is:

1. A method of enabling individual internet users to link advertising information to user-generated video content posted on the internet, the method comprising the steps of:
hosting user-generated video content on an internet site;
enabling individual internet users to view the user-generated video content on the internet site;
enabling the individual internet users to link advertising information to a portion of the user-generated video content on the internet site; and
enabling a reward to be provided to individual internet users who link advertising information to the portion of the user-generated video content on the internet site.

2. A method according to claim 1, wherein the internet site comprises YouTube.

3. A method according to claim 1, wherein the internet site comprises Facebook.

4. A method according to claim 1, wherein the internet site comprises MySpace.

5. A method according to claim 1, wherein the step of enabling a reward to be provided comprises the step of enabling a reward to be provided to individual internet users who link advertising information to the portion of the user-generated video content on the internet site, in response to another individual clicking on the link.

6. A method according to claim 5, wherein the reward is provided when the another individual consummates a purchase through said link.

7. A method according to claim 5, wherein the reward comprises a cash reward.

8. A method according to claim 5, wherein the reward comprises a non-cash reward.

9. A method according to claim 1, wherein the step of enabling the individual internet users to link comprises the steps of:
enabling the individual internet users to select an item in the video content, the item comprising at least one of an object in the video content and a frame of the video content; and
enabling the individual internet users to apply a tag or identifier to the selected object in the video for linking the item to at least one of marketing material and a transaction page.

10. A method according to claim 9, wherein the step of enabling a reward to be provided to individual internet users who link comprises the step of crediting the individual internet users who link for any tags applied by the user in response to another individual user performing a step of at least one of linking to a sponsor's web site and purchasing a sponsor's goods or services following the user's link.

11. A method of enabling individual internet users to link advertising information to content posted on the internet, the method comprising the steps of:
hosting content on an internet site;
enabling individual internet users to view the content on the internet site;
enabling the individual internet users to link advertising information to a portion of the content on the internet site; and
enabling a reward to be provided to individual internet users who link advertising information to the portion of the content on the internet site.

12. The method of claim 1, wherein said content includes at least one of audio content, video content, and image content.

13. The method of claim 1, wherein said video content includes at least one of user generated content and nonuser generated content.

14. Apparatus for enabling individual internet users to link advertising information to user-generated content posted on the internet, comprising:
at least one server for hosting user-generated content on an internet site; and
an interface, coupled to said server and configured to communicate with at least one user computer through the internet;
said at least one server being configured to (i) enable individual internet users to view the user-generated content, (ii) enable the individual internet users to link advertising information to a portion of the user-generated content, and (iii) enable a reward to be provided to individual internet users who link advertising information to the portion of the user-generated content.

15. Apparatus according to claim 14, wherein said user-generated content comprises user-generated video content.

16. Apparatus according to claim 14, wherein said at least one server is configured to enable other internet users who view the user-generated content to click on the link.

17. Apparatus according to claim 15, wherein said at least one server is configured to display a pop-up window in response to the other internet users clicking on the link.

18. Apparatus according to claim 14, wherein said at least one server is configured to direct the other internet users to sponsor's web site in response to the other internet users clicking on the link.

19. Apparatus according to claim 14, wherein said at least one server is configured to include in said link information identifying the individual internet user who placed the link.

20. Apparatus according to claim 14, further comprising an account server, coupled to the internet, which stores information of individual internet users who are registered to place links in said at least one server.
